(19) United States
(12) Patent Application Publication
(10) Pub. No.: US 2024/0119851 A1
(43) Pub. Date: Apr. 11, 2024

(54) METHOD AND SYSTEM FOR PROVIDING LANGUAGE LEARNING SERVICES

(71) Applicant: NAVER Corporation, Seongnam-si (KR)

(72) Inventors: Eun Young LEE, Seongnam-si (KR); Min Jung KIM, Seongnam-si (KR); Yeun Hee KANG, Seongnam-si (KR); Bong Hyun CHOI, Seongnam-si (KR); Tae Un KIM, Seongnam-si (KR); Soo Hyun LEE, Seongnam-si (KR); Young Ho KIM, Seongnam-si (KR); Chan Kyu CHOI, Seongnam-si (KR); Jin Mo KU, Seongnam-si (KR); Jong Won KIM, Seongnam-si (KR)

(21) Appl. No.: 18/478,674

(22) Filed: Sep. 29, 2023

(30) Foreign Application Priority Data
Oct. 7, 2022 (KR) 10-2022-0128685

(51) Int. Cl. G09B 5/02; G06F 3/04845; G06F 3/04886; G06F 40/166; G06F 40/58; G06V 20/50; G06V 20/62; G06V 30/19

(52) U.S. Cl. CPC G09B 5/02; G06F 3/04845; G06F 3/04886; G06F 40/166; G06F 40/58; G06V 20/50; G06V 20/62; G06V 30/19

(57) ABSTRACT

The present invention relates to a method and system for providing language learning services. The method of providing language learning services, according to the present invention, the method may include: activating, in response to receiving an input for acquiring a learning target image through a user terminal, a camera of the user terminal; specifying at least a portion of an image taken by the camera as the learning target image; receiving language learning information for the learning target image from a server; providing the language learning information to the user terminal; and storing, based on a request for storing of the language learning information, the language learning information in association with the learning target image, such that the learning target image is used in conjunction with learning of the language learning information.

### CROSS REFERENCE TO RELATED APPLICATION

The present application claims priority to Korean Patent Application No. 10-2022-0128685, filed on Oct. 7, 2022, the entire contents of which are hereby incorporated by reference.

### BACKGROUND OF THE INVENTION

### Field of the Invention

The present invention relates to a method and system for providing language learning services. More specifically, the present disclosure relates to a method and system for providing an interface for learning about sentences or words included in text recognized from a learning target image.

### Description of the Related Art

As technology advances, electronic devices (e.g., smartphones, tablet PCs, automation devices, etc.) have become more popular, and accordingly, there is an increased dependency on the electronic devices for many aspects of daily life.

In particular, various services have been developed and provided to furnish learners with content for language learning through the electronic devices.

As part of this service, an interface is provided to furnish translation information on text entered by a user, and to store and manage the translation information provided. Moreover, in recent years, services that allow learners to take the initiative in learning and manage a learning situation through the electronic devices have been provided and the use of the services has been highly increasing.

However, recently, these services have been providing translation information and learning content for text entered directly by the user, and there is a need to reduce the time and effort required for the user to enter the text that the user intends to learn.

To solve the need described above, a method of recognizing text from images taken by the user and providing translation information on the recognized text is being introduced. In particular, Korean Patent No. 10-2317482 discloses a method of translating sentences included in an image taken by a user and providing content related to the sentences.

However, these methods of providing language learning content are focused on providing translation information of the text included in the image taken by the user. Therefore, in conjunction with the image taken by the user, it is possible to take further consideration of a service that enables storing learning information on sentences and words included in the image, managing the stored learning information more efficiently and intuitively from the aspect of the learner, and using the learning information for learning.

### BRIEF SUMMARY OF THE INVENTION

The present invention relates to a method and system for providing more convenient language learning services to a user.

Further, the present invention relates to a method and system for providing language learning services that enable a user to proceed more intuitively and efficiently with foreign language learning.

Furthermore, the present invention relates to a method and system for providing language learning services that, in conjunction with an image taken by a user, enables the user to more intuitively and organically manage learning information of a text included in the image.

To achieve the above-mentioned objects, there is provided a method of providing language learning services, the method may include: activating, in response to receiving an input for acquiring a learning target image through a user terminal, a camera of the user terminal; specifying at least some of an image taken by the camera as the learning target image; receiving language learning information for the learning target image from a server; providing the language learning information to the user terminal; and storing, based on a request for storing of the language learning information, the language learning information in association with the learning target image, such that the learning target image is used in conjunction with learning of the language learning information.

Further, a system for providing language learning services in conjunction with a user terminal including a display, according to the present invention, the system may include: a control unit configured to receive learning information from a server through a communication unit, wherein the control unit: acquires, in response to a user's input through the display, a learning target image through the user terminal; receives language learning information on a text recognized from the learning target image from the server; provides the language learning information to the user terminal; and stores the language learning information in association with the learning target image, based on a request for storing the language learning information, such that the learning target image is used in conjunction with learning of the language learning information.

Further, a program stored on a computer-readable recording medium, which is executed by one or more processes on an electronic device, according to the present invention, the program may include instructions for performing: activating, in response to receiving an input for acquiring a learning target image through a user terminal, a camera of the user terminal; specifying at least some of an image taken by the camera as the learning target image; receiving, from a server, language learning information on a text recognized from the learning target image; providing the language learning information to the user terminal; and storing the language learning information in association with the learning target image, based on a request for storing the language learning information, such that the learning target image is used in conjunction with learning of the language learning information, in which the learning information may include a translation of at least one sentence corresponding to the text, and meaning information on at least one word included in the at least one sentence.

As described above, the method and system for providing language learning services according to the present invention may reduce an inconvenience of a user searching by entering separate text to search for translation information by recognizing a text included in an image taken by the user and providing translation information on the recognized text.

Further, the method and system for providing language learning services according to the present invention may enable efficient management of a learning target and learning information by storing a learning target image with learning information on a text included in the learning target image in conjunction with the learning target image.

Furthermore, the method and system for providing language learning services according to the present invention may enable a user to proceed with learning without having a separate means for learning by providing an interface for learning in response to a user's input to a graphic user interface (GUI) including the learning target image.

### BRIEF DESCRIPTION OF THE DRAWINGS

FIG. 1 is a conceptual view for describing a system for providing language learning services according to the present invention.

FIG. 2 is a flowchart for describing a method of providing language learning services according to the present invention.

FIGS. 3(A) and 3(B) are conceptual views for describing a method of specifying a learning target image according to the present invention.

FIGS. 4(A) and 4(B) are conceptual views for describing a method of specifying a learning target image, according to another embodiment.

FIG. 5 is a conceptual view for describing a database according to the present invention.

FIGS. 6A and 6B illustrate a screen including at least one learning page, according to the present invention.

FIG. 7 is a conceptual view for describing a method of displaying a text recognized from a learning target image according to the present invention.

FIGS. 8A and 8B are conceptual views for describing a method of providing learning information on a text recognized according to the present invention.

FIGS. 9A and 9B are conceptual views for describing a method of providing learning information on a text recognized according to another embodiment.

FIGS. 10A and 10B are conceptual views for describing a method of adding learning information based on a user's selection of words included in at least one sentence, according to the present invention.

FIG. 11A is a conceptual view for describing an interface for editing a text recognized according to the present invention.

FIG. 11B is a conceptual view for describing an interface for selecting a learning level according to the present invention.

FIG. 12 is a conceptual view for describing a method of storing learning information according to the present invention with a learning target image.

FIG. 13 is a flowchart for describing a method of displaying learning information for learning, based on a user's input according to the present invention.

FIG. 14 is a conceptual view for illustrating a method of proceeding with learning using learning information according to the present invention.

FIGS. 15A and 15B are conceptual views for describing a method of displaying one of at least one sentence or a translation for at least one sentence, based on a user's input, according to the present invention.

FIGS. 16A and 16B are conceptual views for describing a method of displaying one of at least one word or meaning information for at least one word, in response to a user's input, according to the present invention.

FIG. 17 is a conceptual view for illustrating a method of storing a portion of at least one sentence as a phrase in learning information according to the present invention.

FIGS. 18A and 18B are conceptual views for describing a method of providing an example sentence, a synonym, an antonym, and a usage form for at least one word according to the present invention.

FIG. 19 is a conceptual view for describing a method of learning for stored words based on a user's input to an administration screen according to the present invention.

FIG. 20 is a conceptual view for describing a method of storing at least some of results provided as learning information through a translation interface according to the present invention.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes ‘module’, ‘unit’, ‘part’, and ‘portion’ used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the exemplary embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention relates to a method and system for providing language learning services. More specifically, the present disclosure relates to a method and system for providing an interface for learning using sentences or words included in text recognized from a learning target image.

In this case, a language learning service means a service that allows a user to confirm meaning information, including a translation, for a foreign language text, and may also be understood as a service that provides an interface to proceed with various kinds of learning, including memorization learning and auditory learning using a foreign language text.

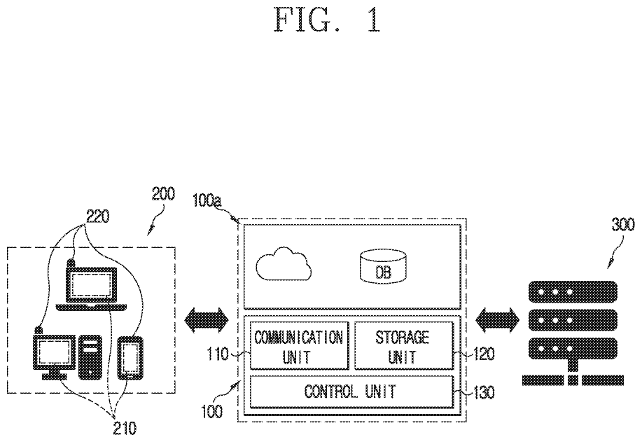

FIG. 1 is a conceptual view for describing a system for providing language learning services according to the present invention.

With reference to FIG. 1, a language learning services providing system 100 of the present invention may receive learning information (or language learning information) related to a text recognized in a learning target image from a learning server 300 based on the learning target image (or the text recognized in the learning target image) received from a user terminal 200, and provide the received learning information to the user terminal 200.

The learning server 300, which is a server providing a translation service, may receive text information (e.g., a word ID) acquired from a specific user terminal 200, and provide meaning information related to the received text information to the system 100 providing language learning services according to the present invention. In certain embodiments, the meaning information for a word may include not only a translation of the word, but also information on synonyms, antonyms, and usage forms of the word, as well as example sentences including the word.

In particular, the learning server 300 according to the present invention may be associated with a dictionary service to provide translation or meaning information for text in a specific language. In this case, the user terminal 200 may correspond to a learner's terminal, and the system 100 for providing language learning services may be an application for providing language learning services implemented on the learner's terminal.

Accordingly, the learning server 300 according to the present invention may be interchangeably referred to as a “language server”, a “dictionary server”, a “translation server”, a “translator server”, a “language learning service server”, and the like.

Specifically, the learning server 300 may provide, to the system 100 for providing language learning services according to the present invention, at least one of: i) translation information for a sentence, ii) meaning information for a word, or iii) sentence information utilizing a word, with respect to a text in a specific language.

Here, the sentence information utilizing a word may include any sentence including the word and translation information about the corresponding sentence.

The meaning information for a word may include at least one of: i) a definition of the word, ii) a synonym and/or antonym for the word, or iii) a usage form of the word.

In addition, the information stored in the learning server 300 may be information entered by an administrator of the learning server 300. According to another embodiment, the information stored in the learning server 300 may be information that the learning server 300 retrieves at a predetermined interval from a designated database (e.g., external storage 100a).

As described above, the learning server 300 according to the present invention may provide various information related to a translation of a text in a specific language in order to provide a language learning service associated with a translation service.

Meanwhile, as illustrated in FIG. 1, the system 100 for providing language learning services may be installed on the user terminal 200 in the form of an application to perform a process of providing language learning services, including a translation. Further, the system 100 for providing language learning services may provide a language learning service to the user terminal 200 in the form of a web service.

Meanwhile, the application may be installed on the user terminal 200 at the request of a user of the user terminal 200, or it may be installed and present on the user terminal 200 prior to shipment of the user terminal 200. As described above, the application implementing the system 100 for providing language learning services may be downloaded from an external data storage (or an external server) through data communication and installed on the user terminal 200. Further, when the application implementing the system 100 for providing language learning services according to the present invention is executed on the user terminal 200, a series of processes may be performed to provide a translation and/or meaning information on a text in a specific language.

Further, the system 100 for providing language learning services according to the present invention is also capable of providing a language learning service to the user terminal 200 in the form of a web service.

A screen (or a page) provided by the system 100 for providing language learning services may include information related to the language learning services and a GUI for language learning.

Meanwhile, when the system 100 for providing language learning services is provided in the form of an application, the screen may be an execution screen of the application, and when the system 100 for providing language learning services is provided in the form of a web service, the page may be understood as a web page.

Hereinafter, it may be understood that the information provided by the system 100 for providing language learning services is included in a “screen” or “page”.

The user terminal 200 as referred to in the present invention may be any electronic device capable of operating the system 100 for providing language learning services according to the present invention, and is not particularly limited in type. For example, the user terminal 200 may include a cell phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)), and the like.

Meanwhile, as described above, the system 100 for providing language learning services according to the present invention, which may be implemented in the form of an application, may include at least one of a communication unit 110, a storage unit 120, or a control unit 130. The constituent elements above are constituent elements in software and may perform functions in conjunction with constituent elements in hardware of the user terminal 200. For example, the control unit 130 may include a computer processing unit, such as a CPU, that includes or is associated with storage unit including any form of computer memory.

For example, the communication unit 110 may perform a role of transmitting and receiving information (or data) related to the present invention to and from at least one external device (or external server 100a) using a configuration of communication modules (e.g., a mobile communication module, a short-range communication module, a wireless Internet module, a location information module, a broadcast reception module, etc.) provided in the user terminal 200.

Further, the storage unit 120 may store information related to the language learning service, information related to the system, and/or instructions using at least one of a memory provided in association with the user terminal 200 and external storage (or the external server, 100a).

In the present invention, “stored” in the storage unit 120 may mean that, physically, the information is stored in the memory of the user terminal 200 or in an external storage device (or the external server 100a).

In the present invention, there is no distinction between the memory of the user terminal 200 and the external storage (or the external server, 100a), and all will be represented and described by the storage unit 120.

Meanwhile, the control unit 130 performs overall control for carrying out the present invention using a central processing unit (CPU) provided in the user terminal 200. The constituent elements described above may operate under the control of the control unit 130, and the control unit 130 may also perform control of the physical constituent elements of the user terminal 200.

For example, the control unit 130 may perform control such that learning information for text in a specific language is output through a display 210 provided on the user terminal 200. In addition, the control unit 130 may perform control such that recording of a video or photograph (or image) is performed through a camera 220 provided in the user terminal 200. In addition, the control unit 130 may receive information from a user through an input unit (not illustrated) of the user terminal 200.

There is no particular limitation on the types of the display 210, the camera 220, and the input unit (not illustrated) provided in the user terminal 200.

Further, while providing learning information for text in a specific language through the display 210 of the user terminal 200, the control unit 130 may receive a request from a user to activate a learning function using the learning information. In response to the user's request to activate the learning function, the control unit 130 may display a GUI (graphical user interface) for proceeding with the learning on the user terminal 200. Therefore, the user is able to perform the learning of identifying and using the learning information.

That is, the system 100 for providing language learning services according to the present invention may provide language learning services including the learning information received from the learning server 300 and the GUI for performing the learning using the learning information by the control unit 130 controlling the communication unit 110 to communicate with the learning server 300.

Hereinafter, a method of providing language learning services that provides learning information on text recognized from a learning target image acquired by a user and displays a GUI for learning using the learning information will be described in more detail.

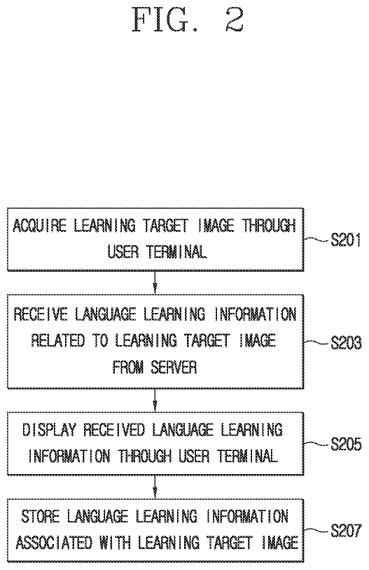

FIG. 2 is a flowchart for describing a method of providing language learning services according to the present invention.

With reference to FIGS. 1 and 2, the control unit 130 may receive learning information related to text included in a learning target image acquired through the user terminal 200 from the server 300, display the learning information through the user terminal 200, and store the learning information with the learning target image.

The control unit 130, according to the present invention, may acquire the learning target image from the user terminal 200 (S201).

For example, the control unit 130 may perform a process of acquiring at least a portion of an image taken through the camera 220 provided in the user terminal 200 as the learning target image (S201). For another example, the control unit 130 may perform a process of acquiring at least a partial area of an image file stored in the user terminal 200 as the learning target image.

As described above, the control unit 130 may acquire the image file (or image) acquired through the camera 220 or various other methods as the learning target image. Meanwhile, the control unit 130 may specify a portion, but not all, of the image file (or image) acquired through the camera or various methods as the learning target image. This may be based on a user's selection from the user terminal 200. In addition, according to another embodiment, the control unit 130 may specify an entire image acquired through the camera, or other method, as the learning target image. Hereinafter, a method of acquiring an image (or an image file) by the control unit 130 and acquiring a learning target image from the acquired image will be described in more detail.

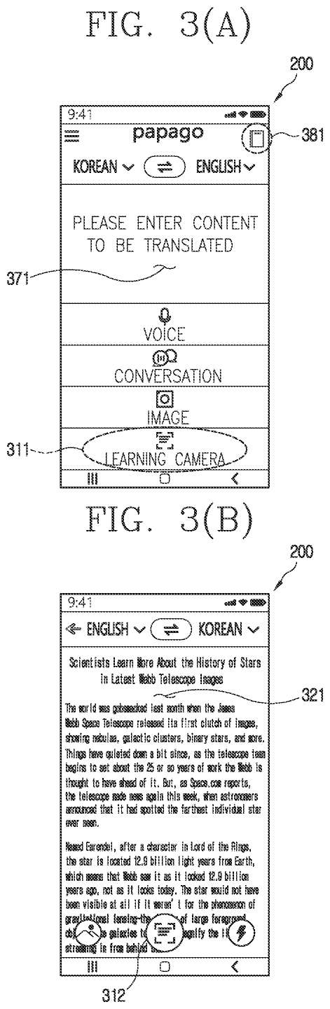

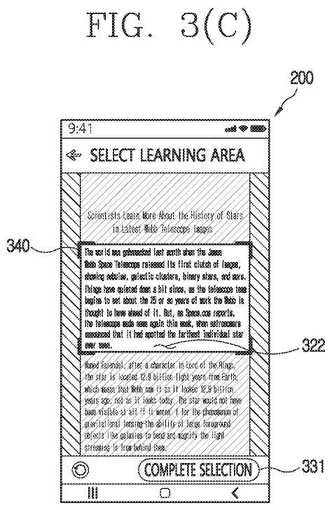

With reference to FIGS. 3(A)-3(C), the control unit 130 may acquire a learning target image 322 through the user terminal 200 in response to receiving a user's input. More specifically, the control unit 130 may acquire the learning target image 322 by activating the camera 220 of the user terminal 200 in response to receiving the user's input to acquire the learning target image 322 through the user terminal 200.

As illustrated in FIG. 3A, a service page provided by the system 100 for providing language learning services is displayed on the user terminal 200. In this case, the service page may include a first icon 311 for activating the camera 220 of the user terminal 200. In addition, the service page may further include a translation interface 371 that receives a text input for translation, and an administration icon 381 for displaying a learning administration screen.

In response to receiving the user's input for the first icon 311 included in the service page, the control unit 130 may activate the camera 220 of the user terminal 200. As illustrated in FIG. 3B, the control unit 130 may acquire an original image 321 by taking an image through the activated camera 220 of the user terminal 200.

To this end, the control unit 130 may provide the image being taken through the camera 220 of the user terminal 200 as a preview image while the camera 220 of the user terminal 200 is activated. Further, the control unit 130 may acquire the original image 321 in response to receiving the user's input for the second icon 312 while the camera 220 of the user terminal 200 is activated. In this case, the original image 321 may be understood as an image that includes text in at least one language. For example, the original image 321 may be understood as an image that includes text in at least one of various different languages, such as English, Japanese, or Chinese, but the language of the text constituting the original image 321 is not limited to the above examples, and other languages are also contemplated as being within the scope of the present invention.

Further, the control unit 130 may specify at least a partial area of the original image 321 acquired through the camera 220 of the user terminal 200 as the learning target image 322. For example, the control unit 130 may provide the user terminal 200 with an interface for selecting at least a partial area of the original image 321 in response to taking (or acquiring) the original image 321 through the camera 220 of the user terminal 200. For example, as illustrated in FIG. 3C, the control unit 130 may display an interface 340 that is in the form of a rectangle, overlaps the original image 321, and is resizable based on the user's input, in response to the original image 321 being taken by the camera 220 of the user terminal 200.

That is, in response to the user's input through the interface 340 displayed with the taken original image 321, the control unit 130 may specify at least a partial area of the original image 321 as the learning target image 322. More specifically, in response to the user's input to a selection icon 331 displayed with the original image 321, the control unit 130 may specify a partial area of the original image 321 as the learning target image 322, corresponding to an area inside the rectangular interface 340 displayed to overlap the original image 321. However, the shape of the interface 340 or the type of icon for specifying the learning target image 322 is not limited to the examples described above, and it may be understood that a variety of shapes and types of interfaces or icons are sufficient to specify at least a partial area of the original image 321 as the learning target image 322.

As described above, the system 100 for providing language learning services according to the present invention may reduce the inconvenience of a user separately entering and searching for a learning target image by specifying at least a portion of the original image 321 taken by the user as a learning target image.

Meanwhile, the process of specifying the learning target image illustrated in FIGS. 3(A)-3(C) is not a required process, and in the present invention, it is, of course, possible that the original image 321 may become the learning target image. For example, when an image is taken by the camera, the taken image may be acquired as the learning target image.

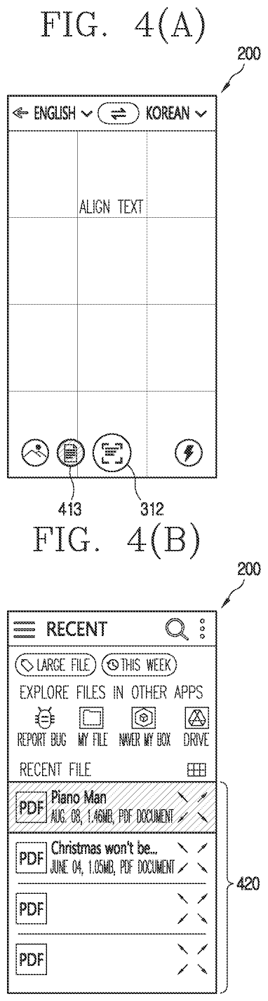

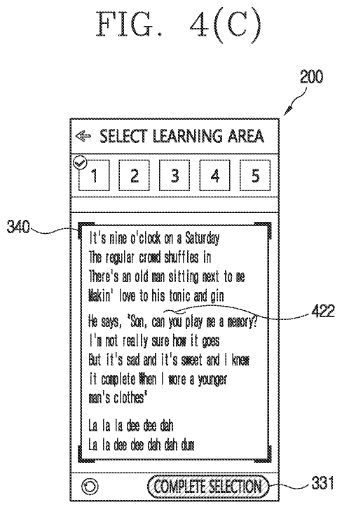

With reference to FIGS. 4(A)-4(C) according to another embodiment of acquiring a learning target image, the control unit 130 may specify a learning target image 422 from an image included in a file stored on the user terminal 200. In these figures, configurations that are identical or substantially identical to the aforementioned configurations are referred to by the same reference numerals, and redundant descriptions are omitted.

As illustrated in FIG. 4A, the control unit 130 may receive an input to a file icon 413.

As illustrated in FIG. 4B, in response to receiving the input to the file icon 413, the control unit 130 may display a file list 420 stored on the user terminal 200 through the user terminal 200. In this case, the file list 420 may include at least one of a file in PDF format or a file in JPG format. For example, the control unit 130 may display a file list of image files in response to an input to a gallery icon of the user terminal 200. In addition, the control unit 130 may display a file list in PDF format in response to an input of a document selection button of the user terminal 200. However, the display method or file format of the file list 420 is not limited to the examples described above.

As illustrated in FIG. 4C, the control unit 130 may display information (or visual information) corresponding to one file of the file list 420. More specifically, the control unit 130 may display information corresponding to a selected file in response to an input to one file of the file list 420 displayed through the user terminal 200.

In this case, the control unit 130 may specify at least a partial area of information corresponding to the selected file as the learning target image 422. More specifically, the control unit 130 may display an interface 340 that allows selection of at least a partial area of the content included in the selected file. Further, in response to an input through the interface 340 displayed through the user terminal 200, the control unit 130 may specify at least a partial area of the information corresponding to the file as the learning target image 422. For example, in response to an input to the selection icon 331, the control unit 130 may specify a partial area of an image corresponding to an area inside the rectangular interface 340 in which information corresponding to a file is displayed to overlap as the learning target image 422.

As described above, the system 100 for providing language learning services according to the present invention may allow a portion of the information corresponding to a file stored in the user terminal 200 to be a learning target image. Meanwhile, even in this case, the process of specifying the learning target image is not a required process, and in the present invention, it is, of course, possible that the content of the file becomes the learning target image.

Meanwhile, the control unit 130 may transmit the learning target image acquired through any of the methods described above to the learning server 300. More specifically, the control unit 130 may receive learning information related to a text included in the learning target image from the learning server 300 by transmitting the learning target image acquired from the user terminal 200 to the learning server 300 (S203 of FIG. 2).

Meanwhile, the control unit 130 may not transmit the learning target image itself to the learning server 300, but may transmit the original text included in the learning target image to the learning server 300. For example, the control unit 130 may receive translated text from the learning server 300 as a translation result for the text by transmitting the original text to the learning server 300.

In this case, the control unit 130 may recognize the text from the acquired learning target image and receive learning information related to the recognized text from the learning server 300 through the communication unit 110.

Hereinafter, a method of, by the control unit 130, transmitting a learning target image or text recognized from the learning target image to the learning server 300 and receiving learning information from the learning server 300 will be described in more detail.

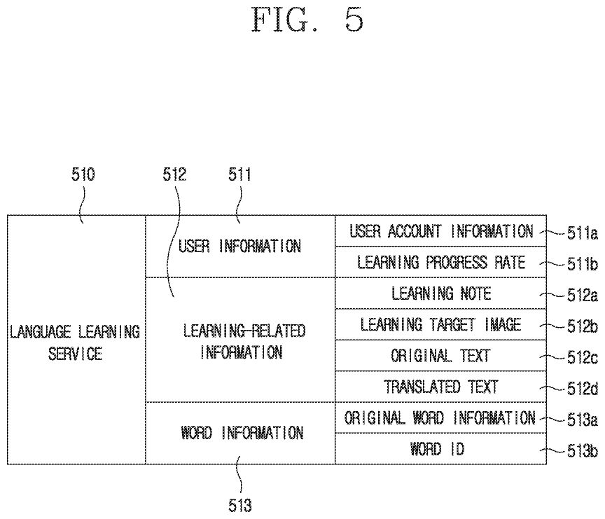

Referring to FIG. 5, the control unit 130 may request translated text 512d for original text 512c by controlling the communication unit 110 to transmit a learning target image 512b and the original text 512c recognized from the learning target image 512b to the learning server 300. Therefore, the control unit 130 may receive the translated text 512d for the original text 512c from the learning server 300 through the communication unit 110. In the pre sent invention, the term “original text” means the text itself included in the learning target image.

In addition, the control unit 130 may receive learning information associated with an original word information 513a and/or a word ID 513b from the learning server 300 by controlling the communication unit 110. More specifically, the control unit 130 may receive meaning information associated with a word corresponding to the transmitted word ID 513b from the learning server 300 by transmitting the original word information 513a or the word ID 513b corresponding to each of the at least one word included in the learning target image 512b to the learning server 300.

Therefore, the system 100 for providing language learning services according to the present invention may maintain the latest of meaning information on words by receiving the meaning information on words from the learning server 300 through the word ID 513b. In addition, the system 100 for providing language learning services according to the present invention may secure an additional storage space of the storage unit 120 by receiving the meaning information on the words from the learning server 300 through the word ID 513b, and not storing the meaning information on the words separately.

Further, the control unit 130 may display learning information received from the learning server 300 through the user terminal 200 (S205). For example, the control unit 130 may display a translated text received from the learning server 300 through the user terminal 200 (S205).

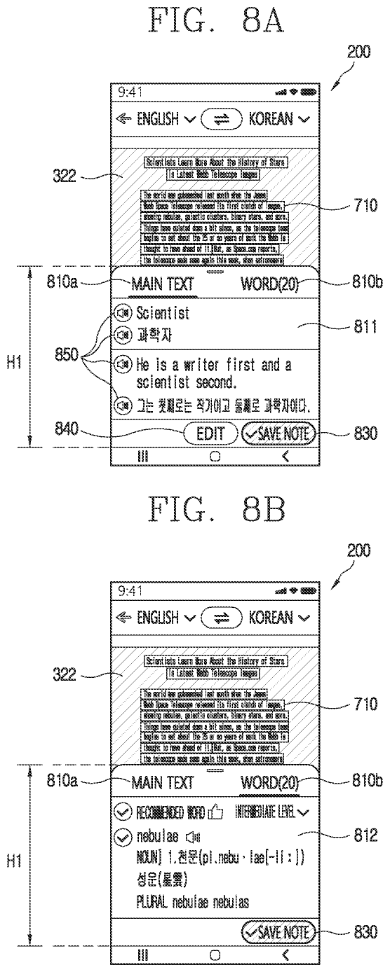

More specifically, the control unit 130 may display, as learning information received from the learning server 300, a translation for at least one sentence included in a text recognized from the learning target image and meaning information on at least one word included in the at least one sentence through the user terminal 200. However, this will be described in more detail below with reference to FIGS. 8A and 8B.

Further, the control unit 130 may store the learning information in association with the learning target image (S207). More specifically, the control unit 130 may store the learning information in the storage unit 120 in association with the learning target image based on a request for storing the learning information.

With reference to FIG. 5, the control unit 130 may store the learning target image 512b acquired from the user terminal 200, with the learning information received from the learning server 300, in the storage unit 120 (S207). In this case, the storage unit 120 may be understood as a storage space of at least one of: a database inside the system 100 providing language learning services, an external server, or the learning server 300.

More specifically, the control unit 130 may store learning information including the learning target image 512b, the original text 512c recognized from the learning target image 512b, and the translated text 512d received from the learning server 300 for the original text 512c, as a learning note 512a of a user. More specifically, the control unit 130 may store the learning target image 512b, original text 512c, and translated text 512d in the form (or unit) of a learning page, in association with user information 511 (or user account information 511a), as the learning note 512a of the user.

In this case, the user information 511 may include the user account information 511a (e.g., user ID, user password (PW)) of the user who uses the language learning service 510, and a learning progress rate 511b (or learning process rate) as the user uses the language learning service 510. However, in addition to the examples described above, the user information 511 may be understood as information identifying a user, or various information associated with the user account information 511a.

Therefore, each of the at least one learning notes 512a stored in the storage unit 120 in association with the user information 511 (or the user account information 511a) may include at least one learning page, which includes at least a portion of the learning target image 512b, the original text 512c, or the translated text 512d.

Further, the control unit 130 may store the meaning information on the words received from the learning server 300, with the learning target image 512b, the original text 512c, and the translated text 512d, in the form of a learning page, as the learning note 512a in association with the user information 511 (or the user account information 511a). In this case, the meaning information for a word may include not only a translation of the word, but also information on synonyms, antonyms, and usage forms of the word, as well as example sentences including the word.

Therefore, as illustrated in FIG. 5, the storage unit 120 may include information related to the language learning service 510. More specifically, the storage unit 120 may include, in relation to the language learning service 510: i) the user information 511 related to a user who is a subject of the service provision, ii) learning-related information 512 pre-stored from learning through the language learning service 510, and iii) word information 513 on words included in text.

For example, the control unit 130 may store the learning information with the learning target image 312b when a request related to storing the learning note (e.g., a request for storing) is received from the user terminal 200 (S207). In this case, the learning target image 312b and the learning information may be stored in association with each other, and the form of being stored in association may be represented as a “learning page” in the present invention. Further, the learning note may be understood to include at least one learning page.

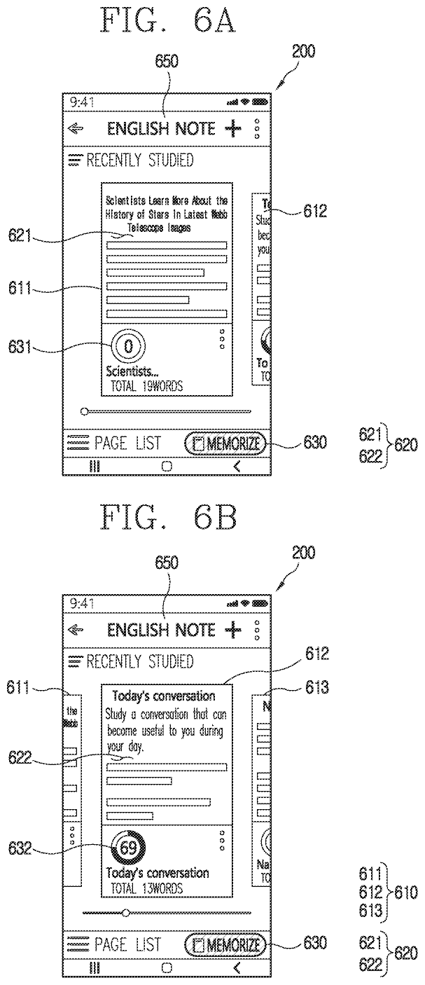

Further, the control unit 130 may display the learning information received from the learning server 300 through the user terminal 200 in the form of a learning page by storing the learning information with the learning target image 312b. However, this will be described in more detail below with reference to FIGS. 6A and 6B.

FIGS. 6A and 6B illustrate a screen (e.g., a graphic user interface (GUI)) including at least one learning page, according to the present invention. With reference to FIGS. 6A and 6B, the control unit 130 may display at least one learning page 611 or 612 included in a learning note 650 through the user terminal 200. More specifically, the learning note 650 may include at least one learning page 611, 612, or 613 configured to include a learning target image 621 or 622. The user account information 511a may be matched with at least one learning note. Each of the at least one learning notes stored in association with the user account information 511a may include at least one learning page 611, 612, or 613 that includes learning information and the learning target image 621 or 622.

As illustrated in FIG. 6A, the first learning page 611 may include at least one of the first learning target images 621 (e.g., the learning target image 322 in FIG. 3) or a first graphic object 631 representing a first learning progress rate for learning information stored on the first learning page 611. Further, although not illustrated, the first learning page 611 may further include learning information stored in association with the first learning target image 621. In the present invention, learning information may be stored in units of learning target images and managed as learning information of a user, and the learning target images 621 and 622 may be provided on the learning pages 611 and 612 described above.

Meanwhile, there may be a plurality of different learning notes that are associated with each other in a user account. A plurality of learning notes may be created based on a user's request, and each learning note may be configured to have a different topic, purpose, etc. Further, as described above, each learning note may include at least one learning page, for example, as illustrated in FIGS. 6A and 6B, a first learning note (e.g., the learning note 650) may include the first learning page 611, the second learning page 612, and the third learning page 613, each including learning information.

As described above, the learning information may be stored as at least one learning page 611 and 612 with the learning target image 621 and 622, and may be managed by a user as a unit of the learning note 650, which includes the at least one learning page 611 and 612.

Further, the control unit 130 may display at least one of the plurality of learning pages 611, 612, and 613 based on an input (e.g., a drag input) to a screen that includes the plurality of learning pages 611, 612, and 613.

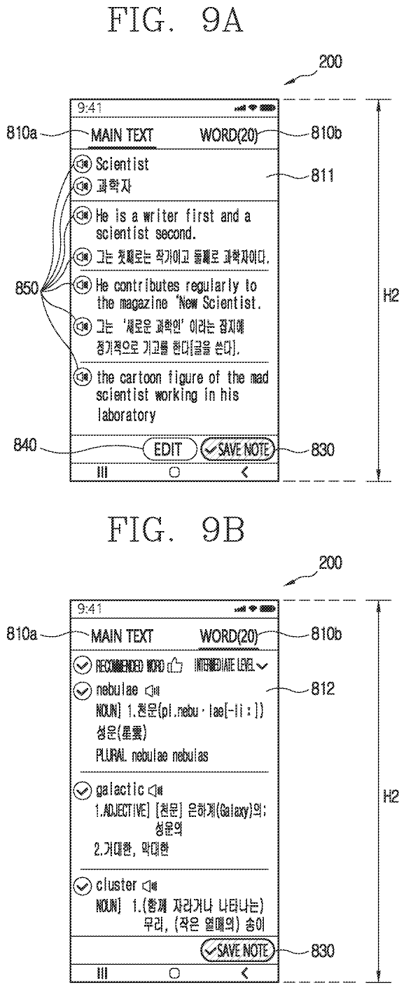

Further, depending on a user's selection, a user's learning may proceed on at least one of the plurality of learning pages 611, 612, and 613 included in the learning note 650. More specifically, in response to the user's selection of one of the plurality of learning pages 611, 612, and 613 included in the learning note 650, the control unit 130 may enable the user to proceed with learning for the selected learning page (e.g., the first learning page 611) by displaying learning information for learning for the selected learning page (see FIGS. 9A and 9B).

The control unit 130 according to the present invention may provide learning for the learning information in units of learning pages 611 and 612 included in the learning note 650. Further, the control unit 130 may independently manage a learning progress rate for the learning that has progressed for each of the learning pages 611 and 612, with respect to the learning provided in units of the learning pages 611 and 612.

Therefore, each learning page may include a different learning progress rate as learning for each learning page progresses independently. For example, as shown in FIGS. 6(A) and 6(B), the first graphic object 631 may indicate that no learning has progressed for the learning information included in the first learning page 612, and a second graphic object 632 may indicate that 69% of the learning has progressed for the learning information included in the second learning page 612.

Here, the learning progress rate may be understood as information indicating a current status of the user's learning with respect to the learning information, based on various standards.

For example, a first learning progress rate and a second learning progress rate may be understood as a memorization rate or achievement rate for meaning information of at least one word recognized from the learning target image 621 and 622, respectively. However, the first learning progress rate and the second learning progress rate are not limited to the examples described above, and may be understood as various kinds of information indicating the user's learning progress status with respect to the learning information received from the learning server 300.

Further, in response to an input to the learning page 611 or 612, the control unit 130 may display the stored learning information with the learning target image 621 or 622. For example, in response to an input to a learning icon 630, the control unit 130 may display at least one card that includes at least one word of the learning information stored with the learning target image 621 or 622 and meaning information on the at least one word that is displayed in response to a user's input, through the user terminal 200. For another example, in response to an input to the included learning target image 621 or 622, the control unit 130 may display at least some 720 of the learning information stored with the learning target image 621 or 622 through the user terminal 200. However, this will be described below in more detail.

In addition, the control unit 130 may display a list of learning pages 611, 612, and 613 through the user terminal 200. More specifically, the control unit 130 may display a list of the plurality of learning pages 611, 612, and 613 in response to an input to icons displayed with the learning pages 611, 612, and 613.

Therefore, the system 100 for providing language learning services according to the present invention may enable a learning target and learning information related to text included in the learning target image 322 to be efficiently managed by storing the learning information in the form of a learning page in a learning note in association with the learning target image.

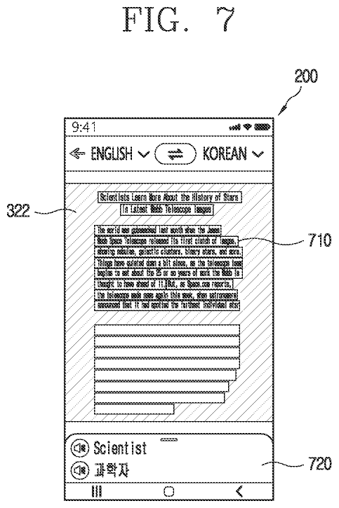

FIG. 7 is a conceptual view for describing a method of displaying text recognized from a learning target image according to the present invention.

With reference to FIG. 7, the control unit 130 according to the present invention may recognize text 710 included in the learning target image 322 and display at least some 720 of the learning information for the recognized text 710 through the user terminal 200.

As illustrated in FIG. 7, the control unit 130 may recognize at least some of the text 710 included in the learning target image 322 through optical recognition for the learning target image 322. In this case, the optical recognition may be implemented as an optical character recognition method, such as optical character recognition (OCR), which may extract text information from an image taken by a photographic means, such as the camera 220 of the user terminal 200. In addition, the optical recognition may be implemented through OCR of an image file included in a file stored on the user terminal 200.

Further, in response to recognizing the text 710 included in the learning target image 322, the control unit 130 may receive learning information related to the text 710 from the learning server 300 through the communication unit 110. More specifically, in response to recognizing the text 710 included in the learning target image 322, the control unit 130 may receive the learning information related to the text 710 from the learning server 300 by transmitting information related to the text 710 to the learning server 300 through the communication unit 110.

According to another embodiment, the control unit 130 may transmit the learning target image 322 to the learning server 300 through the communication unit 110, and receive the text 710 recognized by the optical recognition of the learning server 300 from the learning server 300.

In this case, the control unit 130 may receive the text 710 recognized as a result of the optical recognition and the learning information related to the text 710 from the learning server 300 through the communication unit 110.

Further, the control unit 130 may display at least some 720 of the learning information received from the learning server 300 through the user terminal 200. More specifically, the control unit 130 may display at least some 720 of a translation of at least one sentence corresponding to the text included in the learning target image 322 and meaning information of at least one word included in the at least one sentence through the user terminal 200. For example, at least some 720 of the learning information may include, but is not limited to, a title or first sentence of the text recognized from the learning target image 322.

However, the type, content, and quantity of learning information displayed through the user terminal 200 may be variously understood based on a user's input through the user terminal 200. This will be described in more detail below with reference to FIGS. 8A, 8B, 9A, and 9B.

FIGS. 8A and 8B are conceptual views for describing a method of providing learning information on text recognized according to the present invention. FIGS. 9A and 9B are conceptual views for describing a method of providing learning information on text recognized according to another embodiment.

With reference to FIGS. 8A, 8B, 9A, and 9B, the control unit 130 according to the present invention may display at least some of the learning information 811 or 812 associated with the text 710 recognized from the learning target image 322 through the user terminal 200.

More specifically, the control unit 130 may display a translation 811 for at least one sentence corresponding to the text 710 recognized from the learning target image 322, or meaning information 812 for at least one word included in the at least one sentence.

With reference to FIGS. 8A, 8B, and 7, in response to a user's input to at least some 720 of the learning information 811 or 812 displayed with the text 710 recognized from the learning target image 322, the control unit 130 may display the translation 811 for at least one sentence corresponding to the text 710 or the meaning information 812 for at least one word included in the at least one sentence.

The control unit 130 according to the present invention may separately display the translation 811 for at least one sentence and the meaning information 812 for at least one word included in the at least one sentence according to a user's input to a separate graphic object, such as a tab.

As illustrated in FIGS. 8A and 9A, in response to an input to a first tab 810a, the control unit 130 may display at least one sentence corresponding to the text 710 and the translation 811 for the at least one sentence.

In addition, as illustrated in FIGS. 8B and 9B, the control unit 130 may display at least one word included in at least one sentence and the meaning information 812 for the at least one word in response to an input to a second tab 810b.

Further, the control unit 130 may change the content or quantity of the displayed learning information 811 and 812 in response to an input (e.g., a drag input) to the displayed learning information 811 and 812 through the user terminal 200.

For example, as illustrated in FIGS. 8A and 8B, the control unit 130 may display the learning information 811 and 812 through an interface having a first height H1 from one edge of a display (e.g., the display 210 in FIG. 1) of the user terminal 200. In this case, in response to a user's drag input to the interface having the first height H1, the control unit 130 may display a larger quantity of learning information 811 and 812 through an interface having a second height H2 that is higher than the first height H1, as illustrated in FIGS. 9A and 9B.

Further, in response to a request for storing, the control unit 130 may associate the learning information 811 and 812 with the learning target image 322 and store them together. More specifically, in response to an input to a storing icon 830 displayed with the learning information 811 and 812, the control unit 130 may associate the learning information 811 and 812 with the learning target image 322 and store them together in the form of a learning page (e.g., the first learning page 611 in FIG. 6A).

In addition, as illustrated in FIGS. 8A and 9A, the control unit 130 may display at least one of a listening icon 850 or an editing icon 840, with the translation 811 for at least one sentence. For example, in response to an input to the listening icon 850, the control unit 130 may output a pronunciation of at least one sentence corresponding to the input icon, or a pronunciation of a translation of the at least one sentence, through a speaker provided on the user terminal 200.

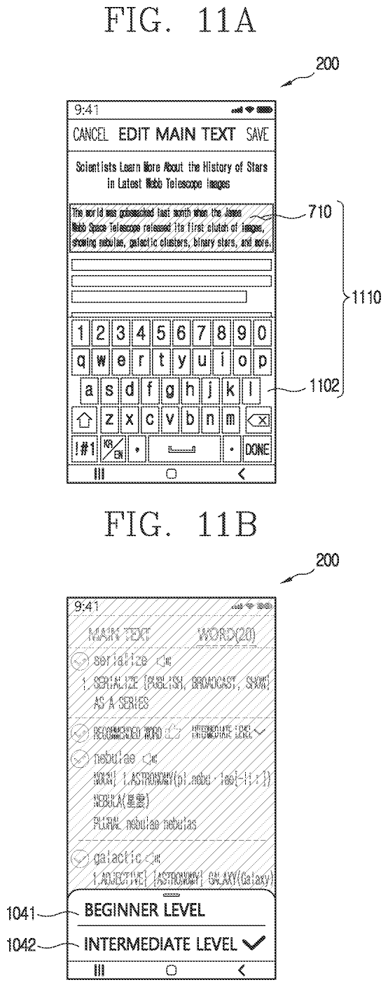

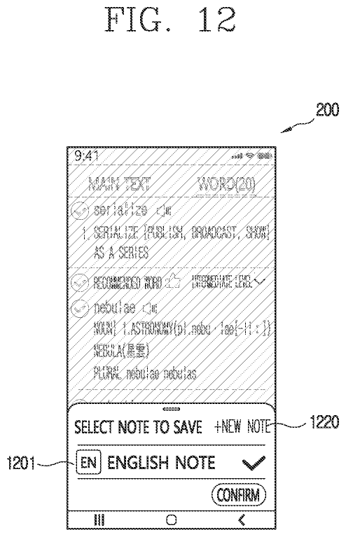

In addition, the control unit 130 may display an editing interface for editing the text 710 in response to an input to the editing icon 840, as described in more detail below with reference to a description of FIG. 11A.

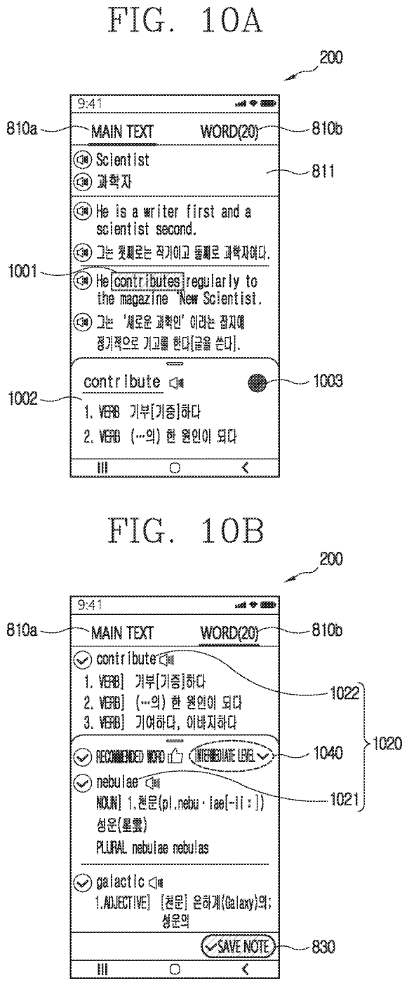

FIGS. 10A and 10B are conceptual views for describing a method of adding learning information based on a user's selection of words included in at least one sentence, according to the present invention.

With reference to FIGS. 10A and 10B, in response to an input of a word 1001 included in at least one sentence, the control unit 130 may store the word 1001 and meaning information 1002 on the word 1001 as learning information.

More specifically, in response to the input of the word 1001 included in at least one sentence, the control unit 130 may display meaning information 1002 on the word 1001, and store the word 1001 and the meaning information 1002 of the word 1001 as learning information.

With reference to FIG. 10B, at least one word 1020 displayed in response to an input to the second tab 810b may include a first word 1021 extracted from at least one sentence based on a pre-input learning level, and a second word 1022 selected in response to an input of some of the at least one sentence (e.g., the word 1001 in FIG. 10A).

The control unit 130 according to the present invention may, in response to an input of the word 1001 included in at least one sentence, store the input word 1001 as the second word 1022.

As illustrated in FIG. 10A, in response to an input for the word 1001 included in at least one sentence, the control unit 130 may display the meaning information 1002 on the selected word 1001. More specifically, while displaying the translation 811 for at least one sentence, the control unit 130 may, in response to receiving an input of the word 1001 included in the at least one sentence, highlight the word 1001, and receive the meaning information 1002 on the word 1001 from the learning server 300 and display the meaning information 1002 through the user terminal 200.

Further, in response to a request for storing the word 1001 and the meaning information 1002 of the word 1001, the control unit 130 may store the selected word 1001 as the second word 1022. More specifically, in response to an input for an icon 1003 displayed with the meaning information 1002 of the word 1001, the control unit 130 may store the word 1001 and the meaning information 1002 of the word 1001 as the second word 1022.

As described above, the system 100 for providing language learning services according to the present invention may display and store meaning information for a word selected by a user, so that the selected word may be used for learning by the user.

FIG. 11A is a conceptual view for describing an interface for editing text recognized according to the present invention. FIG. 11B is a conceptual view for describing an interface for selecting a learning level according to the present invention.

With reference to FIGS. 8A, 9A, and 11A, the control unit 130 may display an editing interface 1110 (FIG. 11A) for editing the text 710 recognized from the learning target image 322.

More specifically, the control unit 130 may display the editing interface 1110 (FIG. 11A) for editing the text 710 in response to an input to the editing icon 840 (FIGS. 8A and 9A) displayed with the translation 811 for at least one sentence.

As illustrated in FIG. 11A, the control unit 130 may include a virtual keyboard 1102 to display the editing interface 1110 that enables editing of the text 710.

More specifically, with reference to FIGS. 8A and 11A, in response to an input to the editing icon 840 displayed with the translation 811 for at least one sentence, the control unit 130 may display the editing interface 1110 including the virtual keyboard 1102 to allow a user to edit the recognized text 710 from the learning target image 322.

According to another embodiment (not illustrated), when the text 710 recognized from the learning target image 322 is Japanese or Chinese, in response to an input to the editing icon 840, an editing interface including a virtual input pad may be displayed to allow a user to edit the text 710 through a handwriting input to the virtual input pad.

As described above, the system 100 for providing language learning services according to the present invention may provide the editing interface 1110 that allows a user to correct errors made during an optical recognition process for the text 710 acquired through optical recognition from the original image 321.

With reference to FIGS. 10B and 11B, the control unit 130 may set (or change) a learning level based on a user's input. Further, the control unit 130 may extract the first word 1021 from at least one sentence based on an input learning level.

As illustrated in FIGS. 10B and 11B, the control unit 130 may display an interface including a plurality of learning levels 1041 and 1042 based on an input to an icon 1040 displayed with the first word 1021 of at least one word 1020.

Further, the control unit 130 may set (or change) a learning level in response to an input to one of the plurality of learning levels 1041 and 1042.

For example, the control unit 130 may set the learning level to a beginner level in response to an input to the first learning level 1041. In this case, the beginner level may be understood as a learning level including words that are included in an elementary or middle school curriculum.

For another example, the plurality of learning levels 1041 and 1042 may be determined by the control unit 130 based on a language type (e.g., Japanese or Chinese) of the text 710 recognized from the learning target image 322, and according to a rating on a certified language test (e.g., JLPT (Japanese-language proficiency test), TOEIC (test of English for international communication) for each language.

Further, the control unit 130 may extract the first word 1021 from at least one sentence based on a set learning level. For example, when the learning level is set to the beginner level, the control unit 130 may extract a word that is included in an elementary or middle school curriculum from at least one sentence as the first word 1021.

According to another embodiment, in response to an input to the icon 1040 displayed with at least one word 1020, the control unit 130 may display an interface that allows a score to be input. More specifically, in response to an input to the icon 1040 displayed with at least one word 1020, the control unit 130 may display an interface that enables a user to input a type of certified language test and a score acquired through the certified language test. Further, the control unit 130 may extract the first word 1021 from at least one sentence based on an input score. For example, the control unit 130 may extract a word according to a learning level by score that is preset in relation to the TOEIC test from at least one sentence as the first word 1021 when a score of 800 on the TOEIC test is input as a learning level.

According to another embodiment, in response to an input to the icon 1040 displayed with at least one word 1020, the control unit 130 may display an interface that includes a survey or questionnaire. More specifically, in response to an input to the icon 1040 displayed with at least one word 1020, the control unit 130 may display an interface that may receive a response to a survey or questionnaire related to the language learning. Further, the control unit 130 may extract the first word 1021 from at least one sentence based on the input response to the survey or questionnaire. For example, the control unit 130 may determine a user's learning level based on the input response, and extract a word according to the determined learning level as the first word 1021 based on a preset standard.

However, the description of the learning level above is illustrative and may be understood as a learning level that is classified according to any one of various different standards.

As described above, the system 100 for providing language learning services according to the present invention may support learning of words that are not yet identified by a user by extracting a word (e.g., the first word 1021) that is suitable for the user's learning level and providing the user with the word.

FIG. 12 is a conceptual view for describing a method of storing learning information according to the present invention with a learning target image.

With reference to FIGS. 6A, 8A, and 12, the control unit 130 may store the learning information 811 and 812 in association with a specific learning note (e.g., the learning note 650 in FIG. 6A) in response to a request for storing.

More specifically, in response to an input to the storing icon 830 displayed with the learning information 811 and 812, the control unit 130 may store the learning information 811 and 812 in association with the specific learning note.

As illustrated in FIG. 12, the control unit 130 may display an interface including at least one learning note list 1201. More specifically, in response to an input to the storing icon 830 displayed with the learning information 811 and 812, the control unit 130 may display an interface including at least one learning note list 1201.

Further, in response to an input to at least one learning note list 1201, the control unit 130 may store the learning information 811 and 812 in association with a selected learning note (e.g., the learning note 650 in FIG. 6A). More specifically, in response to an input to at least one learning note list 1201, the control unit 130 may store the learning information 811 and 812 in association with a selected learning note in the form of a learning page (e.g., the first learning page 611 in FIG. 6A) with a learning target image (e.g., the first learning target image 621 in FIG. 6A).

In addition, the control unit 130 may add a learning note in response to an input to an icon 1220 included in the interface. More specifically, the control unit 130 may add a learning note for a specific language in response to an input to the icon 1220 included in the interface. For example, in response to an input to the icon 1220 included in the interface, the control unit 130 may add a learning note on various languages, including Chinese, or on various topics.

According to another embodiment (not illustrated), in response to an input to the storing icon 830 displayed with the learning information 811 and 812, the control unit 130 may store the learning information 811 and 812 in association with a preset learning note. More specifically, in response to an input to the storing icon 830, the control unit 130 may store the learning information 811 and 812 in association with a preset learning note, without any separate display of the interface including at least one learning note list 1201.

For example, in response to an input to the storing icon 830, the control unit 130 may store the learning information 811 and 812 in association with the most recently generated learning note, based on the points in time at which the plurality of learning notes were generated. For another example, in response to an input to the storing icon 830, the control unit 130 may store the learning information 811 and 812 in association with a preset learning note (e.g., a “default note”).

As described above, the system 100 for providing language learning services according to the present invention may store the learning information 811 and 812 and the learning target image in association with at least one learning note 1201 of the plurality of learning notes, thereby enabling efficient management of a learning target and information related to the learning target.

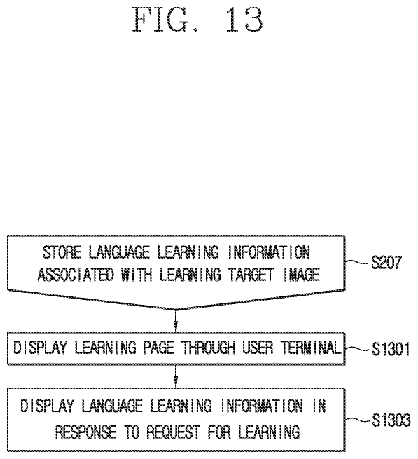

FIG. 13 is a flowchart for describing a method of displaying learning information for learning, based on a user's input according to the present invention. With reference to FIG. 13, the control unit 130 may display the learning information 811 and 812 (FIGS. 8A and 8B) in response to an input to the learning pages 611 and 612 (FIGS. 6A and 6B), which include the learning target images 621 and 622.

More specifically, with reference to FIG. 6A, the control unit 130 may display the learning pages 611 and 612 through the user terminal 200 (S1301). In this case, the learning pages 611 and 612 may include the learning target images 621 and 622.

Further, the control unit 130 may display the learning information 811 and 812 based on a request for learning (S1303). More specifically, in response to an input to the learning page 611, the control unit 130 may display at least some of the learning information 811 and 812 so that a user may proceed with learning using the learning information 811 and 812.

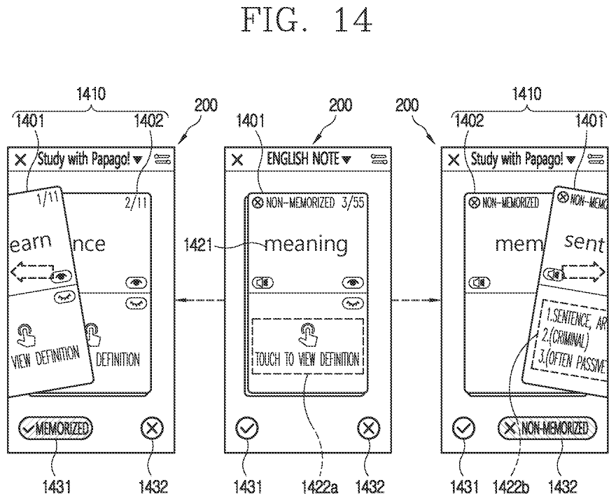

FIG. 14 is a conceptual view for illustrating a method of proceeding with learning using learning information according to the present invention. With reference to FIG. 14, the control unit 130 may display at least one card including a word 1421 and meaning information 1422b on the word 1421 based on a request for learning. More specifically, the control unit 130 may display at least one card including the word 1421 and the meaning information 1422b on the word 1421 so that a user may proceed with learning the meaning information 1422b on the word 1421 based on the request for learning.

For example, with reference to FIG. 6A, in response to an input to the learning icon 630 displayed with the first learning page 611, the control unit 130 may display at least one card 1410 (FIG. 14) that includes the word 1421 and meaning information 1422b on the word 1421 that is displayed in response to a user's input. The control unit 130 according to the present invention may, in response to a user's input, display the meaning information 1422b on the word 1421 through at least one card 1410.

As illustrated in FIG. 14, a first card 1401 may display an interface 1422a that allows a user to identify the meaning information 1422b on the word 1421. Further, the control unit 130 may display the meaning information 1422b on the word 1421 in response to an input to the interface 1422a.

According to another embodiment, the control unit 130 may display the meaning information 1422b on the word 1421 in response to an input to the first card 1401 or an input to a second icon 1432.

In addition, the control unit 130 may receive an input indicating whether a user has memorized the meaning information 1422b on the word 1421.

More specifically, the control unit 130 may classify the word 1421 included on the first card 1401 based on an input to the first card 1401 (e.g., a drag input). Specifically, the control unit 130 may classify the word 1421 included on the first card 1401 into a first state or a second state that is distinct from the first state based on a direction of a drag input to the first card 1401. For example, the control unit 130 may classify the word 1421 into the first state (e.g., a memorized state) in response to a drag input to the first card 1401 that is directed leftward. In addition, the control unit 130 may classify the word 1421 into the second state (e.g., a non-memorized state) that is distinct from the first state in response to a drag input to the first card 1401 that is directed rightward.

In addition, the control unit 130 may move the first card 1401 in a direction in which a drag input is directed, based on a direction of the drag input to the first card 1401. Further, the control unit 130 may move the first card 1401 out of an area displayed through the display 210, and display the second card 1402, in response to a drag input to the first card 1401.

According to another embodiment, the control unit 130 may move the first card 1401 out of an area displayed through the display 210 of the user terminal 200, and display the second card 1402, in response to an input to the first icon 1431 or the second icon 1432. For example, the control unit 130 may move the first card 1401 out of the area displayed through the display 210 in a leftward direction in response to receiving an input to the first icon 1431. In addition, the control unit 130 may move the first card 1401 out of the area displayed through the display 210 in a rightward direction in response to receiving an input to the second icon 1432.

In addition, while displaying the word 1421 through the first card 1401, the control unit 130 may classify the word 1421 into the first state (e.g., a memorized state) in response to receiving an input to the first icon 1431. In addition, while displaying the word 1421 through the first card 1401, the control unit 130 may classify the word 1421 into the second state (e.g., a non-memorized state) in response to receiving an input to the second icon 1432.

In this case, the first icon 1431 and the second icon 1432 may each change into a form that includes a text indicating a corresponding state, in response to receiving a user's input. For example, the first icon 1431 may change into a form that includes a text such as “memorized” in response to receiving a user's input. In addition, the second icon 1432 may change into a form that includes a text such as “non-memorized” in response to receiving a user's input. However, the shapes of the first icon 1431 and the second icon 1432 are not limited to the examples described above and may be understood to have various shapes that are able to provide a classification result for the word 1421 in response to a user's input.

As described above, the system 100 for providing language learning services according to the present invention may display (or provide) the learning information 811 and 812 through the user terminal 200 so that a user may proceed with memorization learning using the learning information 811 and 812 even if the user does not have separate learning means.

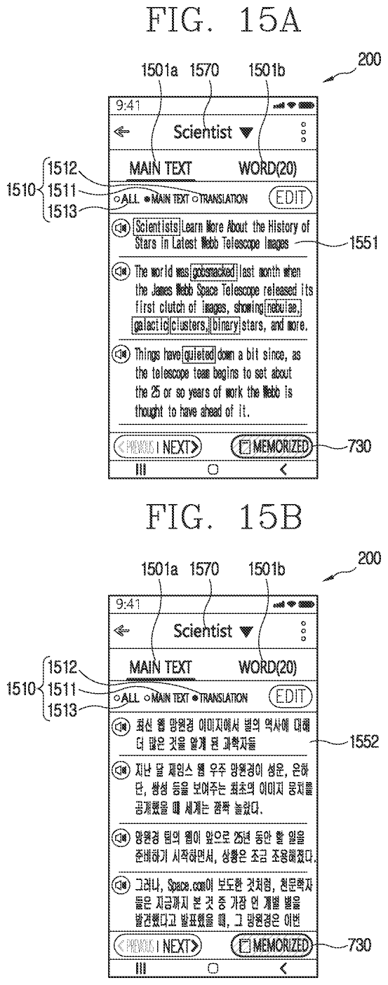

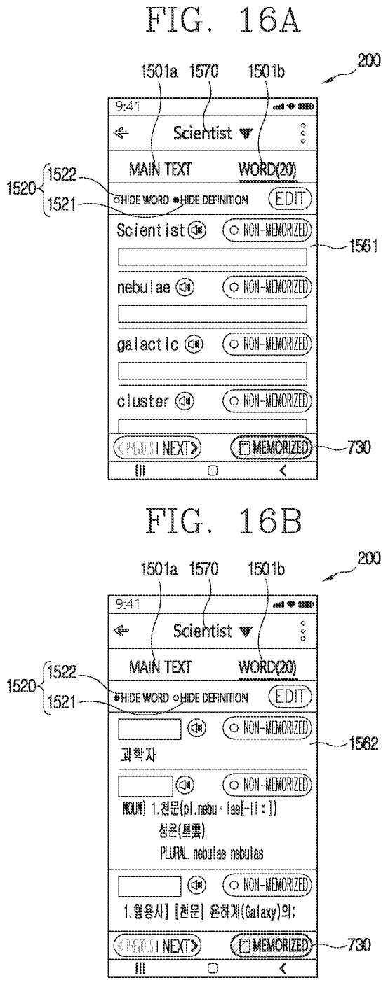

FIGS. 15A and 15B are conceptual views for describing a method of displaying one of at least one sentence or a translation for at least one sentence, based on a user's input, according to the present invention. FIGS. 16A and 16B are conceptual views for describing a method of displaying one of at least one word or meaning information for at least one word, in response to a user's input, according to the present invention.

With reference to FIGS. 15A, 15B, 16A, and 16B, the control unit 130 may display one of at least one sentence 1551 or a translation 1552 for the at least one sentence 1551, or one of at least one word 1561 or meaning information 1562 for the at least one word 1561.

As illustrated in FIGS. 15A and 15B, the control unit 130 may display one of at least one sentence 1551 or the translation 1552 for the at least one sentence 1551 in response to a request for learning. More specifically, in response to an input to some of the first icons 1510 displayed according to an input to the first tab 1501a, the control unit 130 may display one of the at least one sentence 1551 or the translation 1552 for the at least one sentence 1551.

For example, the control unit 130 may display at least one sentence 1551 in response to an input to a first one 1511 of the first icon 1510 displayed according to an input to the first tab 1501a. In addition, the control unit 130 may display the translation 1552 for at least one sentence 1551 in response to an input to a second one 1512 of the first icon 1510. Further, the control unit 130 may display at least one sentence 1551 and the translation 1552 for the at least one sentence 1551 in response to an input to a third one 1513 of the first icon 1510.

According to another embodiment (not illustrated), when the text 710 recognized from the learning target image 322 is Japanese, the control unit 130 may display or omit furigana notations for at least one word or at least one sentence included in the recognized text 710 based on an input through the user terminal 200.

According to another embodiment (not illustrated), when the text 710 recognized from the learning target image 322 is Chinese, the control unit 130 may display or omit Pinyin notations for at least one word or at least one sentence included in the recognized text 710 based on an input through the user terminal 200.

As described above, the system 100 for providing language learning services according to the present invention may allow a user to learn the meaning of at least one sentence 1551 by displaying in a format such that one of the at least one sentence 1551 or the translation 1552 for the at least one sentence 1551 is omitted.

In addition, as illustrated in FIGS. 16A and 16B, the control unit 130 may display only one of at least one word 1561 or meaning information 1562 for the at least one word 1561 in response to a request for learning. More specifically, in response to an input to some of the second icons 1520 displayed according to an input to the second tab 1501b, the control unit 130 may display only one of at least one word 1561 or the meaning information 1562 for the at least one word 1561.

For example, the control unit 130 may display at least one word 1561 in response to an input to a first one 1521 of the second icon 1520. In addition, the control unit 130 may display the meaning information 1562 for at least one word 1561 in response to an input to a second one 1522 of the second icon 1520.

As described above, the system 100 for providing language learning services according to the present invention may allow a user to proceed with learning at least one word 1561 by displaying in a format such that one of the at least one word 1561 or the meaning information 1562 for the at least one word 1561 is omitted.

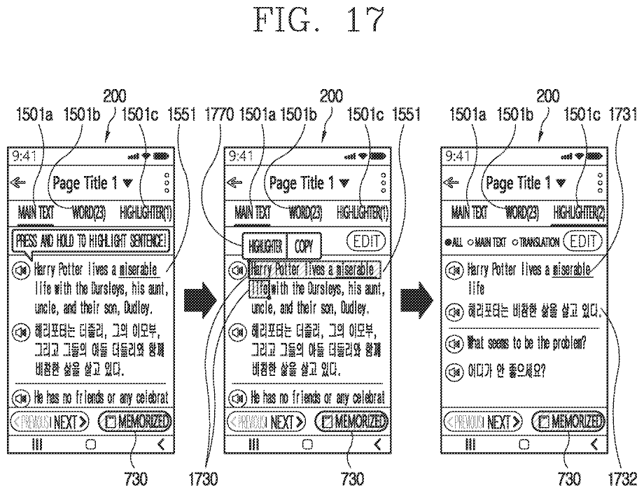

FIG. 17 is a conceptual view for illustrating a method of storing a portion of at least one sentence as a phrase in learning information according to the present invention. With reference to FIG. 17, the control unit 130 may store a portion 1730 of at least one sentence 1551 corresponding to the recognized text 710 in the learning target image 322 as learning information.

More specifically, the control unit 130 may store at least the portion 1730 selected from at least one sentence 1551 corresponding to the recognized text 710 from the learning target image 322 as a phrase 1731 included in the learning information.

As illustrated in FIG. 17, in response to receiving an input to an area of at least one sentence 1551, the control unit 130 may highlight the portion 1730 that is included in the area of the sentence to which the input is received. Further, the control unit 130 may store the highlighted portion 1730 of at least one sentence 1551 as the phrase 1731. To this end, in response to an input to an area of at least one sentence 1551, the control unit 130 may display a graphic object 1770 for storing the portion 1730 included in the area to which the input is received as the phrase 1731. Further, in response to an input to a portion of the graphic object 1770 (e.g., “highlighter”), the control unit 130 may store the portion 1730 of the at least one sentence 1551 as the phrase 1731. In addition, the control unit 130 may copy the portion 1730 of the at least one sentence 1551 to a clipboard in response to an input to another portion of the graphic object 1770 (e.g., “copy”).

In addition, the control unit 130 may display at least a portion of the stored phrase 1731 or translation information 1732 on the phrase 1731. More specifically, in response to an input to the third tab 1501c, the control unit 130 may display at least a portion of the stored phrase 1731 or the translation information 1732 on the phrase 1731. For example, in response to an input to a portion of icons displayed according to an input to the third tab 1501c, the control unit 130 may display only one of the phrase 1731 or the translation information 1732 on the phrase 1731.

As described above, the system 100 for providing language learning services according to the present invention may provide an interface for separately storing and managing some phrases of the at least one sentence 1551 that correspond to the text 710 recognized from the learning target image 322.

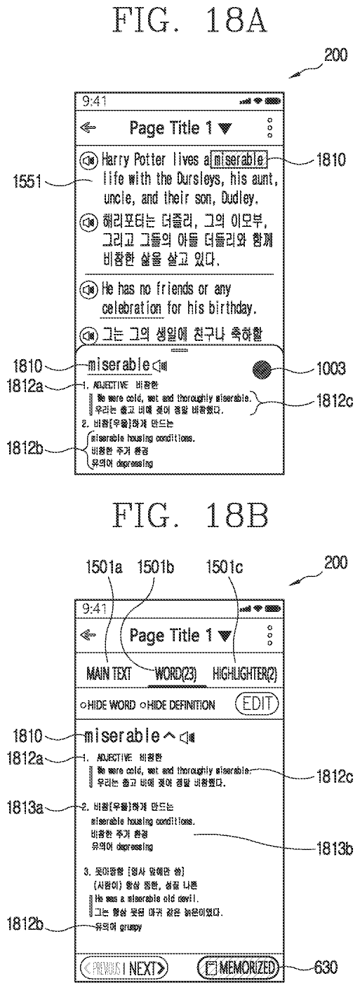

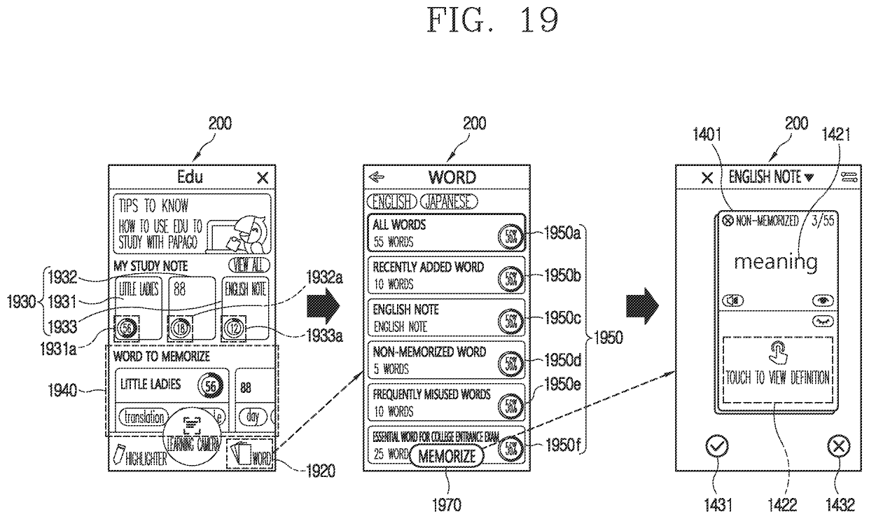

FIGS. 18A and 18B are conceptual views for describing a method of providing an example sentence, a synonym, an antonym, and a usage form for at least one word according to the present invention.

With reference to FIGS. 18A and 18B, the control unit 130 may display additional information 1812b, including synonyms, antonyms, and usage forms for a word 1810, and a first sentence 1812c including the word 1810, through the user terminal 200.

With reference to FIG. 18A, in response to an input to the word 1810 included in at least one sentence 1551 displayed through the user terminal 200, the control unit 130 may display at least a portion of the additional information 1812b, including synonyms, antonyms, and usage forms of the word 1810 or the first sentence 1812c including the word 1810, along with first meaning information 1821a of the word 1810. More specifically, in response to an input to the word 1810 included in the at least one sentence 1551, the control unit 130 may highlight the input word 1810 and display at least a portion of the additional information 1812b, including synonyms, antonyms, and usage forms of the word 1810 or the first sentence 1812c including the word 1810, along with first meaning information 1821a of the highlighted word 1810.

As illustrated in FIG. 18A, in response to a request for storing, the control unit 130 may store the word 1810, the first meaning information 1812a of the word 1810, the additional information 1812b, and the first sentence 1812c including the word 1810. More specifically, in response to an input to the icon 1003 displayed with the meaning information 1812a on the word 1810, the control unit 130 may store the word 1810, the first meaning information 1812a of the word 1810, the additional information 1812b, and the first sentence 1812c including the word 1810 as learning information.

As illustrated in FIG. 18B, the control unit 130 may display the stored word 1810, the first meaning information 1812a for the word 1810, the additional information 1812b, and the first sentence 1812c including the word 1810, through the user terminal 200. More specifically, in response to an input to the second tab 1501b, the control unit 130 may display the stored word 1810, the first meaning information 1812a of the word 1810, the additional information 1812b, and the first sentence 1812c including the word 1810. Further, the control unit 130 may display a second sentence 1813b in which the word 1810 is used according to second meaning information 1813a, along with the first sentence 1812c in which the word 1810 is used according to the first meaning information 1812a.

As described above, the system 100 for providing language learning services according to the present invention may provide, for the word 1810 included in the learning target image, the meaning information 1812a and 1813a, as well as the additional information 1812b including usage forms, synonyms and antonyms, and example sentences (e.g., the first sentence 1812c and the second sentence 1813b) using the word 1810.

FIG. 19 is a conceptual view for describing a method of learning for stored words based on a user's input to an administration screen according to the present invention.

With reference to FIG. 19, the control unit 130 may display a plurality of graphic objects 1930 corresponding to a plurality of learning notes through the user terminal 200.

More specifically, in response to an input to the administration icon 381 displayed through the user terminal 200, the control unit 130 may display the plurality of graphic objects 1930 corresponding to the plurality of learning notes. It should be not that configurations that are identical or substantially identical to the aforementioned configurations are referred to by the same reference numerals, and redundant descriptions are omitted.

As illustrated in FIG. 19, the control unit 130 may display icons 1931a, 1932a, and 1933a representing a note learning progress rate for each learning note through the plurality of graphic objects 1930 corresponding to the plurality of learning notes.

More specifically, the control unit 130 may display the icons 1931a, 1932a, and 1933a representing a note learning progress rate for each learning note through the plurality of graphic objects 1930 representing the plurality of learning notes that correspond to a type of language in the text 710 recognized from the learning target image 322.

For example, a first graphic object 1931 corresponding to a first learning note may include the first icon 1931a representing a first note learning progress rate for words included in the first learning note. Further, a second graphic object 1932 corresponding to a second learning note may include the second icon 1932a representing a second note learning progress rate for the words included in the second learning note. Further, a third graphic object 1933 corresponding to a third learning note may include the third icon 1933a representing a third note learning progress rate for the words included in the third learning note.

For example, the first icon 1931a may represent a state where the first note learning progress rate for the words included in the first learning note is 56%, the second icon 1932a may represent a state where the note learning progress rate for the words included in the second learning note is 18%, and the third icon 1933 may represent a state where the note learning progress rate for the words included in the third learning note is 12%.

In this case, the note learning progress rate may be a rate of words classified as a first state according to learning, among the words stored in at least one learning page included in each learning note. For example, the first note learning progress rate displayed through the first graphic object 1931 may be understood to correspond to a sum of the first learning progress rate and the second learning progress rate in FIGS. 6A and 6B.

In addition, the control unit 130 may display a plurality of icons 1930 corresponding to the plurality of learning notes, and a current status of learning 1940 for the words stored in the plurality of learning notes. In this case, the current status of learning 1940 may include a plurality of learning notes arranged according to the order in which a user progressed through the learning. In addition, each learning note may be displayed to include a learning progress rate and words that have been learned in the corresponding learning note.

Further, in response to an input to an icon 1920, the control unit 130 may display a list 1950 of word groups that each include a plurality of words. For example, in response to an input to the icon 1920, the control unit 130 may display at least one of a first list 1950a including words included in all learning notes, a second list 1950b including words stored for a designated period of time, a third list 1950c including words in a specific language, a fourth list 1950d including words classified as the second state, a fifth list 1950e including words classified according to learning results, or a sixth list 1950f including words acquired from an external database.

Further, the control unit 130 may display the words included in each of the lists 1950a, 1950b, 1950c, 1950d, 1950e, and 1950f in response to an input to some of the list 1950.

In addition, in response to an input to some of the list 1950, and an input to a learning icon 1970 displayed with the list 1950, the control unit 130 may display learning information to support memorization learning for words included in the selected list (e.g., the first list 1950a). In this case, it may be understood that the learning information is displayed in the same manner as in the embodiment illustrated in FIG. 14.

According to another embodiment, in response to the selection of each of the plurality of graphic objects 1931, 1932, and 1933, the control unit 130 may display at least one learning page (e.g., the first learning page 611 and the second learning page 612 in FIG. 6A) included in a learning note (e.g., the learning note 650 in FIG. 6A) corresponding to the selected graphic object (e.g., the first graphic object 1931).

Further, in response to a request for learning for the at least one learning page displayed, the learning information included in the at least one learning page may be displayed. In this case, it may be understood that the learning information is displayed in the same manner as in the embodiment illustrated in FIG. 14.

As described above, the system 100 for providing language learning services according to the present invention may provide a learning interface for words stored in learning notes by learning notes, as well as a learning interface for words according to a separate list.

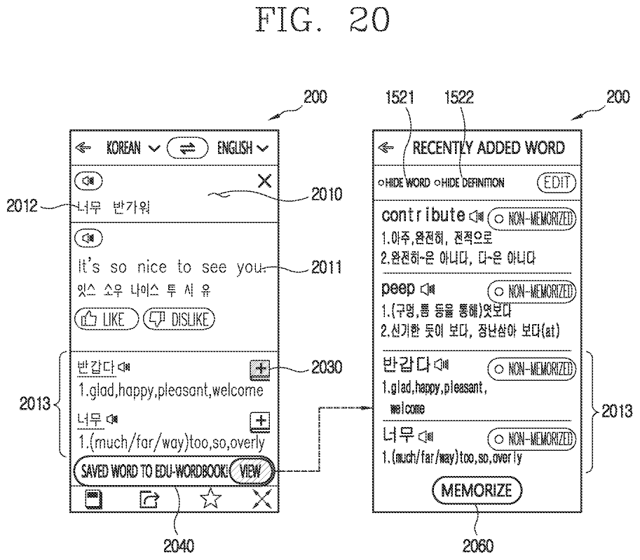

FIG. 20 is a conceptual view for describing a method of storing at least some of the results provided as learning information through a translation interface according to the present invention.

With reference to FIG. 20, the control unit 130 may display a translation interface 2010 that receives a text input 2011 and provides a translation result 2012 for the text input 2011. Once again, it should be note that configurations that are identical or substantially identical to the aforementioned configurations are referred to by the same reference numerals, and redundant descriptions are omitted.

As illustrated in FIG. 20, the control unit 130 may provide the translation result 2012 for the text input 2011 in response to the text input 2011. According to another embodiment (not illustrated), in response to an image input to the translation interface 2010, the control unit 130 may provide a translation result for the image input.

Further, the control unit 130 may store at least some of the translation results 2012 provided through the translation interface 2010 as the learning information 811 and 812. More specifically, the control unit 130 may store meaning information 2013 of a word that is included in the translation results 2012 provided through the translation interface 2010 as learning information.

For example, in response to an input to an icon 2030 displayed with the meaning information 2013 for a word, the control unit 130 may store at least some of the meaning information 2013 of the word as learning information.

In addition, the control unit 130 may display learning information including the meaning information 2013 of the word. More specifically, in response to an input to a graphic object 2040 displayed according to storing at least some of the meaning information 2013 of the word, the control unit 130 may display learning information that includes the meaning information 2013 of the word.

Further, in response to an input to a learning icon 2060 displayed with the meaning information 2013 of the word, the control unit 130 may display learning information for learning the word (e.g., the meaning information 812 in FIG. 8B). In this case, it may be understood that the learning information is displayed in the same manner as in the embodiment illustrated in FIG. 14.

As described above, the system 100 for providing language learning services according to the present invention may also store sentences or words included in the translation results 2012 provided as a result of the translation interface 2010 in the learning information 811 and 812, thereby enabling efficient management of a learning target and learning information regardless of the path by which the target sentences and words were acquired.

Meanwhile, the computer-readable medium referenced herein includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined based on the reasonable interpretation of the appended claims, and all of the modifications within the equivalent scope of the present invention belong to the scope of the present invention.

What is claimed is:

1. A method of providing language learning services, the method comprising:
acquiring, in response to receiving an input for acquiring a learning target image through a user terminal, the learning target image through the user terminal:
receiving language learning information for the learning target image from a server;
providing the language learning information to the user terminal; and
storing, based on a request for storing of the language learning information, the language learning information in association with the learning target image, such that the learning target image is used in conjunction with learning of the language learning information.

2. The method of claim 1, wherein the language learning information comprises:
a translation of a sentence included in text recognized from the learning target image; and
meaning information of a word included in the sentence.

3. The method of claim 2, comprising:
displaying, through the user terminal, a learning page including the learning target image; and
displaying, in response to a request for learning for the learning page, the language learning information stored with the learning target image, such that the language learning information is used for learning.

4. The method of claim 3, wherein the storing of the language learning information in association with the learning target image comprises storing the language learning information in a learning note including the learning page, such that the language learning information is managed as the learning page with the learning target image.

5. The method of claim 4, wherein the learning page further comprises information indicating a learning progress rate for the learning page, and
wherein the learning progress rate comprises a learning progress state using the language learning information stored with the learning target image on the learning page.

6. The method of claim 4, further comprising:
displaying, through the user terminal, a plurality of graphic objects corresponding to a plurality of learning notes;
displaying, in response to a selection of one of the plurality of graphic objects, at least one learning page included in the learning note corresponding to the selected graphic object; and
displaying, in response to a request for learning for the at least one learning page, language learning information included in the at least one learning page.

7. The method of claim 6, wherein the plurality of graphic objects comprises information indicating note learning progress rates for the plurality of learning notes, and
wherein the note learning progress rate comprises a learning progress state using language learning information stored in a learning page included in each of the plurality of learning notes.

8. The method of claim 3, comprising:
displaying, based on a request for learning for the learning page, a card including the word and meaning information of the word; and
determining, based on a direction of a drag input to the card, a user's learning state for the word included in the card; and
classifying, based on the determination of the learning state, the word as either a first state or a second state, where the second state is distinct from the first state.

9. The method of claim 2, wherein the word recognized from the learning target image comprises at least one of a recommended learning word extracted from the sentence based on a pre-input learning level, or a selected learning word selected through a user's input to one or more words included in the sentence.

10. The method of claim 9, comprising:
displaying meaning information for a specific word selected by the user's input among words included in the learning target image; and
storing the specific word as the selected learning word.

11. The method of claim 2, wherein the language learning information further comprises phrase learning information related to a phrase included in the sentence, and
wherein the method comprises:
highlighting, in response to a user's input being applied in a preset manner for a specific portion of the sentence through the user terminal, a phrase corresponding to the specific portion to be distinct from other portions; and
storing the phrase corresponding to the specific portion as the phrase learning information.

12. The method of claim 2, further comprising:
displaying, in response to a request for editing for the text recognized from the learning target image, an editing interface configured to allow editing of the text by including a virtual keyboard.

13. The method of claim 1, wherein the acquiring of the learning target image through the user terminal comprises:
activating, in response to receiving an input for acquiring the learning target image, a camera of the user terminal; and
specifying at least a portion of an image taken by the camera as the learning target image.

14. The method of claim 1, further comprising:
displaying a translation interface configured to receive text input and to provide a translation result for the text input through the user terminal; and
storing meaning information of a word included in the translation result provided through the translation interface as the language learning information stored in association with the learning target image.

15. A system for providing language learning services in conjunction with a user terminal including a display, the system comprising:
a control unit configured to receive learning information from a server through a communication unit,
wherein the control unit:
acquires, in response to a user's input through the display, a learning target image through the user terminal;
receives language learning information of a text recognized from the learning target image from the server;
provides the language learning information to the user terminal; and
stores the language learning information in association with the learning target image, based on a request for storing the language learning information, such that the learning target image is used in conjunction with learning of the language learning information.

16. The system of claim 15, wherein the language learning information comprises a translation of a sentence corresponding to the text and meaning information of a word contained in the sentence.

17. The system of claim 16, wherein the control unit, in response to receiving an input for acquiring the learning target image:
loads a file stored on the user terminal; and
specifies at least a partial area of an image included in the file as the learning target image.

18. The system of claim 16, wherein the control unit:
displays, through the display, a learning page including the learning target image; and
displays, in response to a request for learning for the learning page, the language learning information stored with the learning target image, such that the language learning information is used for learning.

19. The system of claim 16, further comprising:
a storage unit including a word ID corresponding to the word,
wherein the control unit transmits, through the communication unit, the word ID stored in the storage unit to the server to receive meaning information on the word corresponding to the transmitted word ID from the server.

20. A program stored on a computer-readable recording medium, which is executed by one or more processes on an electronic device, the program comprising instructions for performing:
activating, in response to receiving an input for acquiring a learning target image through a user terminal, a camera of the user terminal;
specifying at least a portion of an image taken by the camera as the learning target image;
receiving, from a server, language learning information on text recognized from the learning target image;
providing the language learning information to the user terminal; and
storing the language learning information in association with the learning target image, based on a request for storing the language learning information, such that the learning target image is used in conjunction with learning of the language learning information,
wherein the learning information comprises a translation of at least one sentence corresponding to the text, and meaning information about at least one word included in the at least one sentence.
